(19) United States
(12) Patent Application Publication
(10) Pub. No.: US 2020/0092432 A1
(43) Pub. Date: Mar. 19, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Ryosuke MASUKO, Kanagawa (JP)

(73) Assignee: FUJI XEROX CO., LTD., Tokyo (JP)

(21) Appl. No.: 16/559,657

(22) Filed: Sep. 4, 2019

(30) Foreign Application Priority Data
Sep. 13, 2018 (JP) 2018-171352

(51) Int. Cl. H04N 1/00

(52) U.S. Cl. CPC H04N 1/00517; H04N 2201/0094; H04N 1/00437

(57) ABSTRACT

An information processing apparatus includes an extracting unit and a display controller. The extracting unit extracts a specific item from among at least one or more items in accordance with history information indicating a history in which a setting value has been set. The display controller performs control such that when a display target representing the extracted specific item is moved in a direction from one end of a screen toward the other end of the screen opposing the one end and displayed, the display target is displayed in a highlighted manner.

### CROSS-REFERENCE TO RELATED APPLICATIONS

This application is based on and claims priority under 35 USC 119 from Japanese Patent Application No. 2018-171352 filed Sep. 13, 2018.

### BACKGROUND

### (i) Technical Field

The present disclosure relates to an information processing apparatus and a non-transitory computer readable medium.

### (ii) Related Art

In recent years, information processing apparatuses that include a function of enabling to easily find a specific display target when the display target is browsed while being moved vertically or horizontally has been suggested (for example, see Japanese Patent No. 5865039).

An information processing apparatus described in Japanese Patent No. 5865039 includes display control means for performing control such that an address that has been used a predetermined number of times or more for a specific period is displayed in a state different from that for other addresses while a user is scrolling an address book including destinations for data transmission by performing a specific operation for which intentional adjustment on the speed of scrolling is difficult, such as a flick operation, an operation on a scroll button, or the like, and such that a specific address is not displayed in a state different from that for the other addresses while the user is scrolling the address book by performing an operation that is synchronized with the speed of scrolling, such as a drag operation, an operation on a scroll bar, or the like.

### SUMMARY

In the case where a list of items for setting conditions to execute functions of an apparatus is displayed on the apparatus, it may be difficult to find a specific item from the displayed list of items, depending on the number of items forming the list.

Aspects of non-limiting embodiments of the present disclosure relate to providing an information processing apparatus and a non-transitory computer readable medium that are able to make a specific item noticeable while items are being moved on a screen, regardless of the speed of movement of the items.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including an extracting unit and a display controller. The extracting unit extracts a specific item from among at least one or more items in accordance with history information indicating a history in which a setting value has been set. The display controller performs control such that when a display target representing the extracted specific item is moved in a direction from one end of a screen toward the other end of the screen opposing the one end and displayed, the display target is displayed in a highlighted manner.

### BRIEF DESCRIPTION OF THE DRAWINGS

Exemplary embodiments of the present disclosure will be described in detail based on the following figures, wherein:

FIG. 1 is a block diagram illustrating an example of a control system of an image forming apparatus according to an exemplary embodiment;

FIG. 2 is a diagram illustrating an example of a history information table;

FIGS. 3A to 3C are diagrams illustrating examples of a setting display screen;

FIG. 4 is a diagram illustrating an example of a display state of a setting display screen;

FIG. 5 is a diagram illustrating an example of a display state of a setting display screen;

FIG. 6 is a flowchart illustrating an example of an operation of the image forming apparatus illustrated in FIG. 1;

FIG. 7 is a flowchart illustrating an example of an operation of the image forming apparatus illustrated in FIG. 1; and

FIG. 8 is a diagram illustrating a modification of a display state of a setting display screen.

### DETAILED DESCRIPTION

Hereinafter, exemplary embodiments of the present disclosure will be explained with reference to drawings. In each figure, component elements that have substantially the same function will be referred to with the same sign, and redundant explanation will be omitted. For example, an image forming apparatus will be explained as an information processing apparatus. However, an information processing apparatus is not limited to an image forming apparatus.

### Embodiments

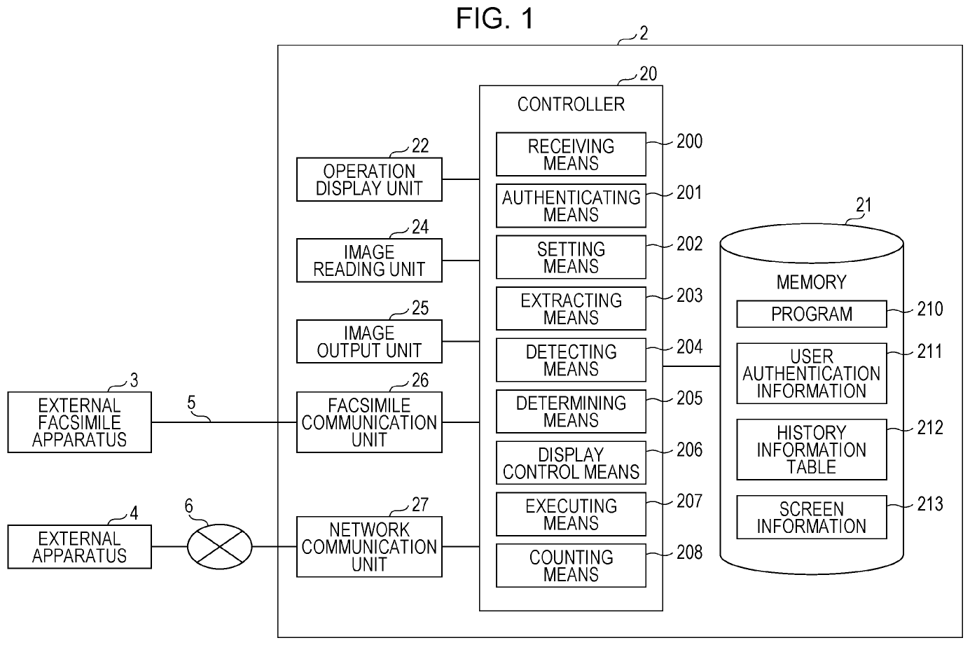

FIG. 1 is a block diagram illustrating an example of a control system of an image forming apparatus according to an exemplary embodiment of the present disclosure. An image forming apparatus 2 is a multifunction apparatus that includes a plurality of functions such as, for example, a scan function, a printer function, a copy function, a facsimile function, and an electronic mail function. The image forming apparatus 2 is not limited to a multifunction apparatus. Furthermore, a “function” may be referred to as a “service”.

As illustrated in FIG. 1, the image forming apparatus 2 includes a controller 20 that controls units of the image forming apparatus 2, a memory 21 that stores various data, an operation display unit 22 that inputs and displays information, an image reading unit 24 that reads a document image from a document, an image output unit 25 that prints and outputs an image, a facsimile communication unit 26 that performs facsimile transmission and reception to and from an external facsimile apparatus 3 via a public network 5, and a network communication unit 27 that communicates with an external apparatus 4 via a network 6.

The controller 20 includes a central processing unit (CPU), an interface, and the like. The CPU functions as receiving means 200, authenticating means 201, setting means 202, extracting means 203, detecting means 204, determining means 205, display control means 206, executing means 207, counting means 208, and the like when operating in accordance with a program 210 stored in the memory 21. Details of the receiving means 200, the authenticating means 201, the setting means 202, the extracting means 203, the detecting means 204, the determining means 205, the display control means 206, the executing means 207, and the counting means 208 will be described later.

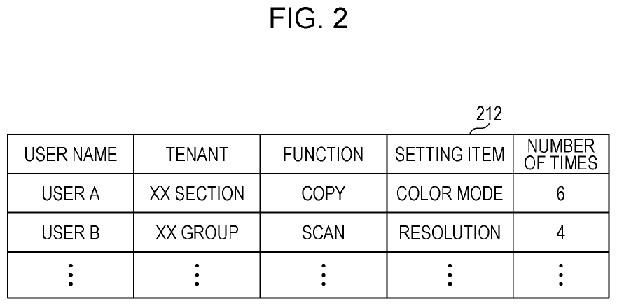

The memory 21 includes a read only memory (ROM), a random access memory (RAM), a hard disk, and the like. Various data such as the program 210, user authentication information 211, a history information table 212 (see FIG. 2), and screen information 213 are stored in the memory 21. Hereinafter, the term “record” is used for the case where information is written into a table, and the term “store” is used for the case where information is written into the memory 21.

In the user authentication information 211, for example, information indicating an operator (hereinafter, may be referred to as a “user”) to be used for authentication of a user (hereinafter, may be simply referred to as “user authentication” or “log-in”), such as the name of the user, identification information for identifying the user, or the like (hereinafter, may be simply referred to as “user information”) is recorded. Furthermore, in the user authentication information 211, information indicating an attribute such as an organization or the like to which a user belongs to (hereinafter, may be referred to as a “tenant”) may be recorded, along with the user information. A “tenant” may be a company, an office, a department, a group, or the like.

FIG. 2 is a diagram illustrating an example of the history information table 212. In the history information table 212, a history in which a setting value is set for an item (hereinafter, may be referred to as a “setting item”) for setting a condition for executing each function (hereinafter, may be simply referred to as an “execution condition”) is recorded in association with a user who performs the setting. A setting item is an example of an item.

The term “setting” represents not only setting a new setting value for a setting item for which no setting value is set but also, for example, setting a certain default value as a setting value for a setting item for which the default value is set in advance (for example, in a case where a setting value is stored in a specific place such as the memory 21 or the like), changing the default value into another value, and the like.

As illustrated in FIG. 2, the history information table 212 is provided with a “user name” field, a “tenant” field, a “function” field, a “setting item” field”, a “number of times” field, and the like, and corresponding information is recorded in each of the above-mentioned fields. The number of times that a setting value has been set for a setting item is recorded in the “number of times” field. The number of times is obtained by the counting means 208, which will be described later.

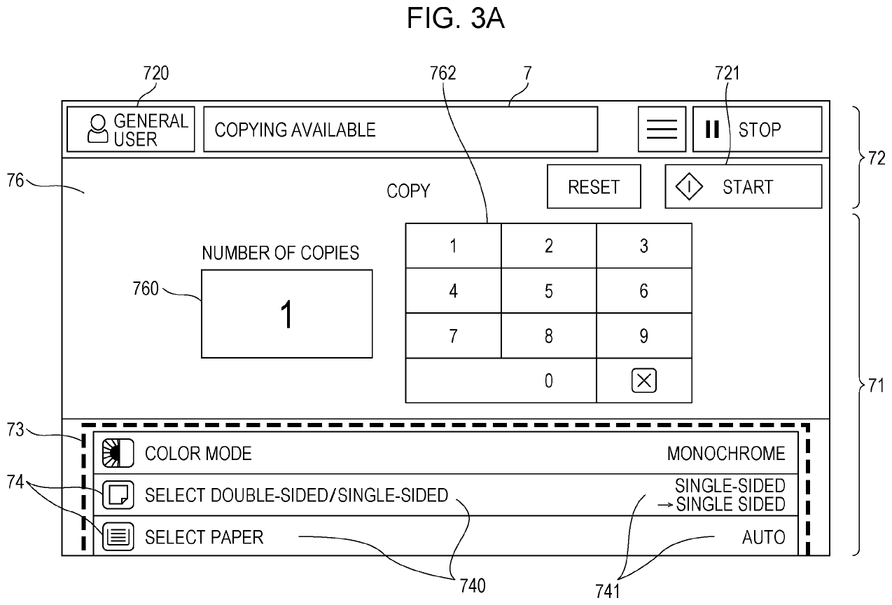

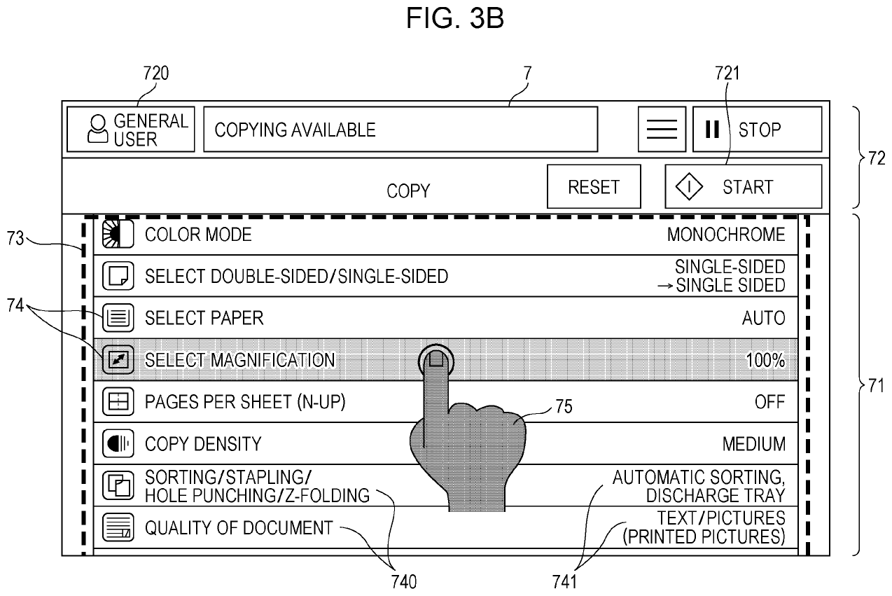

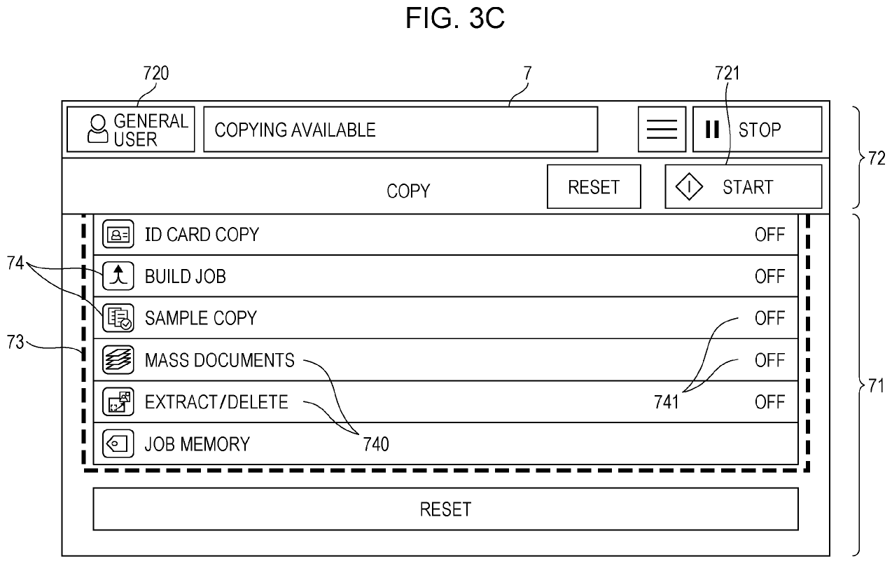

In the screen information 213, information regarding a screen displayed on a display screen (not illustrated in figures) of the operation display unit 22 by the display control means 206, which will be described later, is recorded. Examples of the screen information 213 will be explained with reference to FIGS. 3A to 3C. FIGS. 3A to 3C are diagrams illustrating examples of a setting display screen.

A setting display screen 7 is a screen for setting an execution condition for a function to be executed and displaying the set execution condition. The setting display screen 7 is provided for each function. For example, a copy function, out of the plurality of functions mentioned above, will be explained below.

As illustrated in FIGS. 3A to 3C, the setting display screen 7 includes a scroll region 71 in which a display target is moved on the screen in a direction from the upper end toward the lower end of the screen (hereinafter, may be simply referred to as a “vertical direction”) and displayed (hereinafter, may be referred to as “scrolled”) and a non-scroll region 72 in which a display target is displayed in a fixed manner.

In the scroll region 71, a number-of-copies operation part 76 and a list 73 indicating execution conditions for the copy function (hereinafter, may be referred to as a “list”, see a frame indicated by a dotted line) are displayed. As illustrated in the order of FIG. 3A, FIG. 3B, and FIG. 3C, parts of the number-of-copies operation part 76 and the list 73 that are not able to be displayed in the scroll region 71 are moved in the vertical direction in accordance with a scroll operation and displayed.

The list 73 includes setting display fields (hereinafter, may be referred to as “content”) 74 in which first character strings 740 that indicate setting items that are able to be set in accordance with an operation by a user and second character strings 741 that indicate setting values set for corresponding setting items are indicated. As illustrated in FIGS. 3A to 3C, setting items for the copy function include, for example, an input item regarding input conditions for the size of a document and the like, output items regarding output conditions for a color state, double-sided/single-sided selection, magnification, density, N-up, and the like, and state items regarding an output state such as sorting, stapling/non-stapling, hole punching/non-hole punching, and the like. Each of the plurality of pieces of content 74 is an example of a display target.

Furthermore, as illustrated in FIG. 3B, a setting item displayed in each of the plurality of pieces of content 74 may be set by operating the content 74 (see reference sign “75”). Specifically, when content 74 is operated, a setting screen (not illustrated in Figures) for inputting or selecting a setting value and a selection field (not illustrated in figures) such as a pull-down menu are displayed.

The schematic diagram 75 representing a finger and a round mark that are illustrated in FIG. 3B and the color of the ground (that is, background) of the content 74 are provided, for the sake of convenience of explanation, to explain that specific content 74 is being selected, and they are not necessarily displayed on the actual display screen. Furthermore, the dotted frame is illustrated for the sake of convenience of explanation and is not necessarily displayed on the actual display screen.

The number-of-copies operation part 76 includes a number-of-copies display part 760 for displaying the set number of copies and a number-of-copies setting part 762 for setting the number of copies. The number-of-copies setting part 762 may be, for example, numeric keys. In the scroll region 71, the number-of-copies operation part 76 and the list 73 are scrolled and displayed.

The non-scroll region 72 includes, for example, a user display field 720 indicating an authenticated user (that is, a user who has logged into the image forming apparatus 2), a start button 721 for issuing an instruction to execute the function, and the like.

The operation display unit 22 is, for example, a touch panel display, and has a configuration in which a touch panel is located on a display such as a liquid crystal display in a superimposed manner. The operation display unit 22 may have a configuration in which an input unit and an operation unit (not illustrated in figures) are provided separately from a display unit.

The image reading unit 24 reads a document image from a document. The image reading unit 24 includes an automatic document feeding device (not illustrated in figures) provided on a document table (not illustrated in figures) and a scanner. The image reading unit 24 optically reads a document image from a document arranged on the document table or sent from the automatic document feeding device.

The image output unit 25 prints and outputs a color image or a monochrome image to a recording medium such as paper using, for example, an electrophotographic system, an inkjet system, or the like.

The facsimile communication unit 26 performs modulation and demodulation of data in accordance with a facsimile protocol such as G3, G4, or the like, and performs facsimile communication with the external facsimile apparatus 3 via the public network 5.

The network communication unit 27 is implemented by a network interface card (NIC). The network communication unit 27 performs transmission and reception of signals to and from the external apparatus 4 via the network 6. The network 6 is, for example, a local area network (LAN), a wide area network (WAN), the Internet, an intranet, or the like. The network 6 may be wired or wireless.

(Receiving Means, Authenticating Means, Setting Means, Extracting Means, Detecting Means, Determining Means, Display Control Means, Executing Means, and Counting Means)

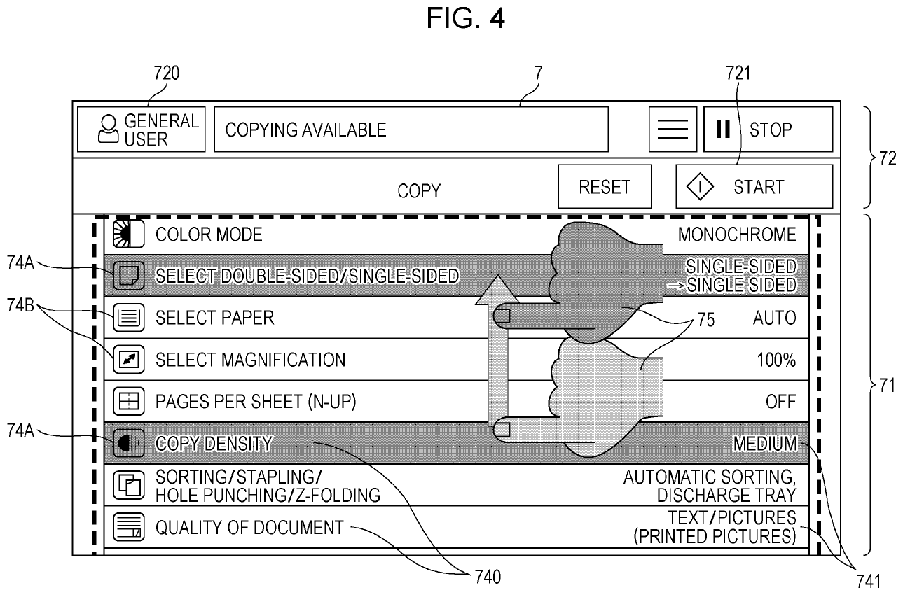

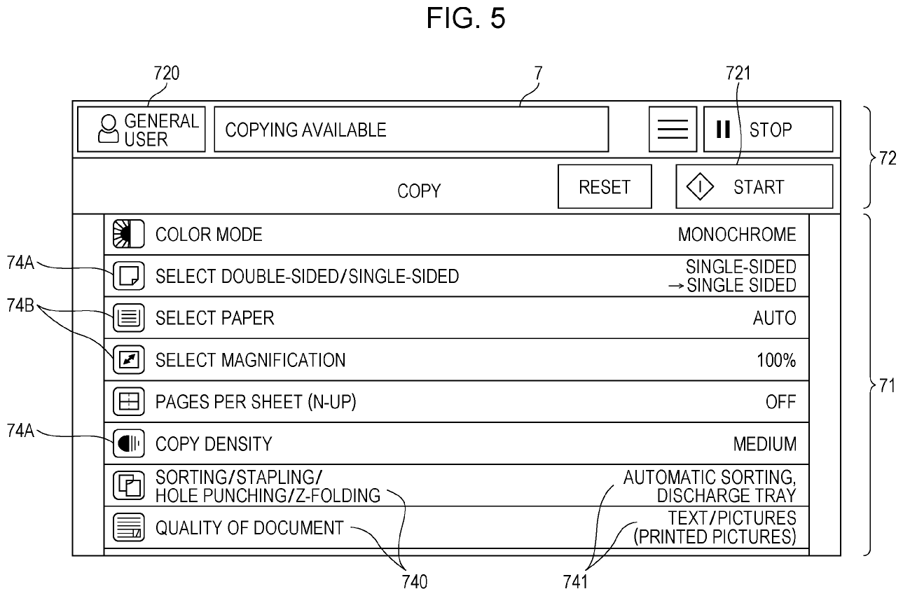

Next, the receiving means 200, the authenticating means 201, the setting means 202, the extracting means 203, the detecting means 204, the determining means 205, the display control means 206, the executing means 207, and the counting means 208 configuring the controller 20 will be explained with reference to FIGS. 4 and 5. FIG. 4 is a diagram illustrating an example of a display state of the setting display screen 7 during a scroll operation. FIG. 5 is a diagram illustrating an example of a display state of the setting display screen 7 when a scroll operation is stopped. The receiving means 200 receives various types of information and operation signals input from the operation display unit 22 and the external apparatus 4.

The authenticating means 201 performs authentication of a user in accordance with information regarding a request for authentication from the user (hereinafter, may be referred to as an “authentication request”). Specifically, the authenticating means 201 performs authentication of a user by comparing user information included in an authentication request with user information recorded in the user authentication information 211 in the memory 21.

For example, an authentication request may be performed by inputting information necessary for authentication to the operation display unit 22 and the external apparatus 4 or may be performed by reading information recorded on a recording medium such as an IC card.

The setting means 202 sets a setting value for a setting item in accordance with an operation by a user for the content 74.

The extracting means 203 extracts, in accordance with a history recorded in the history information table 212, a specific setting item from among at least one or more setting items corresponding to a selected function. Specifically, the extracting means 203 extracts a specific setting item for which a history recorded in the history information table 212 satisfies a predetermined condition.

More specifically, the extracting means 203 refers to the history information table 212 stored in the memory 21 to extract a setting item (hereinafter, may be referred to as a “first setting item”) for which the number of times that a setting value has been set (hereinafter, may be referred to as the “number of setting times”) is equal to or more than a first reference number of times (may be simply referred to as the “reference number of times”), as an example of a predetermined condition. One or a plurality of first setting items may be extracted by the extracting means 203.

The first reference number of times is an example of a predetermined number. The number of times as a criterion for the extraction may be set for each user.

The detecting means 204 detects an operation for moving a display target in the vertically direction, the operation being performed for the operation display unit 22 (hereinafter, may be referred to as a “scroll operation”). Furthermore, the detecting means 204 detects stoppage of a scroll operation.

Scroll operations to be detected by the detecting means 204 include, for example, an operation for flicking a display screen (not illustrated in figures) of the operation display unit 22 (that is, a “flick operation”), an operation for tracing while a finger being in contact with the display screen (that is, a “drag operation”), an operation for moving a scroll bar (not illustrated in figures), an operation for pressing a scroll button (not illustrated in figures), and the like.

Furthermore, the detecting means 204 detects an operation for the content 74 on a screen displayed on the operation display unit 22.

The determining means 205 determines whether or not first content 74A regarding the first setting item extracted by the extracting means 203 is being displayed in the scroll region 71 of the setting display screen 7.

The display control means 206 performs control such that each screen and each type of information are displayed on a display screen (not illustrated in figures) of the operation display unit 22. Furthermore, in the case where the first content 74A is being displayed in the scroll region 71 during the period from detection of a scroll operation by the detecting means 204 to detection of stoppage of the scroll operation by the detecting means 204, that is, during the period in which a scroll operation is being performed, the display control means 206 performs control such that the first content 74A is displayed more noticeably than second content 74B regarding other setting items (hereinafter, may be referred to as “second setting items”).

Specifically, the display control means 206 performs, as an example of a noticeable state, such that a first setting item is displayed in a highlighted manner (hereinafter, may be simply referred to as “highlighted”). More specifically, as illustrated in FIG. 4, the display control means 206 performs control such that the first content 74A is displayed in a color different from the color of the second content 74B. The arrow in FIG. 4 represents a direction of a scroll operation. The arrow and the schematic diagram 75 representing a finger are illustrated for the sake of convenience of explanation and are not necessarily displayed on the actual display screen.

The display control means 206 may change one or both of the ground color of the content 74 and the color of text illustrated in the content 74, as the color of the content 74. A combination of different colors is not limited to a combination of specific colors. However, the display control means 206 may perform control such that, for example, in the case where the second content 74B is displayed without color or white, the first content 74A is displayed in a warm color such as red, yellow, or the like.

As an example of highlighting the content 74, the display control means 206 may display the content 74 while increasing the height or width of the content 74 or increasing the size of text.

Furthermore, when the detecting means 204 detects that a scroll operation is stopped, the display control means 206 performs control such that the state of display of the first content 74A (hereinafter, may be simply referred to as a “display state”) is returned to the original state. Specifically, as illustrated in FIG. 5, the display control means 206 performs such that highlighting of the first content 74A is canceled and the first content 74A is displayed in the same display state as the display state of the second content 74B.

The executing means 207 controls the image reading unit 24, the image output unit 25, the facsimile communication unit 26, and the like to execute each function in accordance with an instruction by a user.

The counting means 208 adds and records a history in which a setting value is set for a setting item into the history information table 212 in the memory 21, and obtains the number of setting times for each setting item by counting information indicating histories recorded in the history information table 212 (hereinafter, may be referred to as “history information”).

For example, the counting means 208 obtains the number of setting times for each user. That is, the counting means 208 obtains the number of setting times that the corresponding user has performed setting, and outputs the obtained number of setting times. Furthermore, the counting means 208 may obtain the number of setting times when a function is executed by the executing means 207, when a setting value is set, or when a setting value is input.

### Operation in Exemplary Embodiment

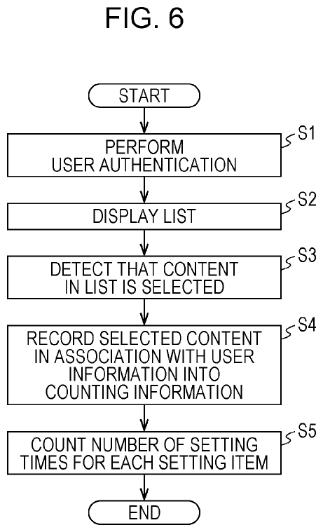

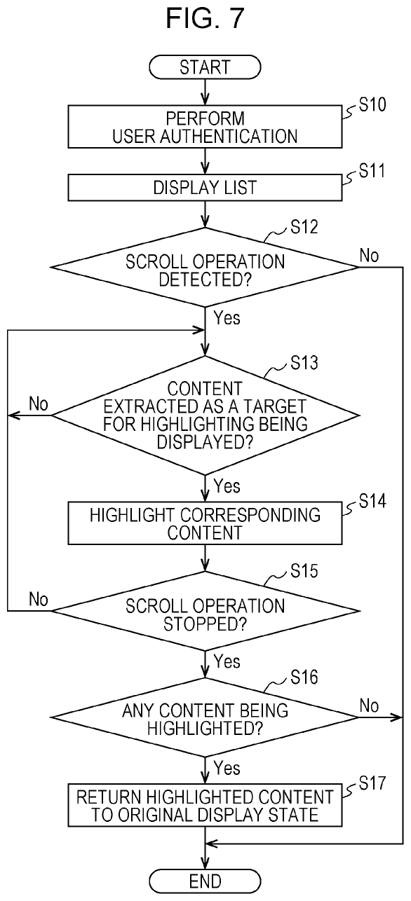

Next, an example of an operation of the image forming apparatus 2 will be explained with reference to FIGS. 6 and 7. In the explanation provided below, an operation of the image forming apparatus 2 will be divided into (1) operation for counting history information and (2) operation for scrolling the list 73.

### (1) Operation for Counting History Information

FIG. 6 is a flowchart illustrating an example of an operation for counting history information of the image forming apparatus 2. When the receiving means 200 receives an authentication request from a user, the authenticating means 201 performs user authentication (S1).

Next, the display control means 206 performs control such that the list 73 is displayed on the display screen of the operation display unit 22 in accordance with a function designated by the user (S2).

When the user performs an operation for selecting specific content 74 from the list 73 displayed on the display screen and the receiving means 200 receives the operation, the detecting means 204 detects that the content 74 in the list 73 is selected (S3).

Next, the counting means 208 records the selected content 74 in association with user information regarding the login user into the history information table 212 in the memory 21 (S4).

The content 74 may be recorded at the time when a specific setting value is set or input for the selected content 74, as described above, or at the time when the function is executed by the executing means 207. “The time when the function is executed” includes the time at which the execution starts, the time at which the execution ends, a specific time in the process of execution, and the like.

Next, the counting means 208 counts histories recorded in the history information table 212 and obtains the number of setting times for each setting item (S5).

### (2) Operation for Scrolling List

FIG. 7 is a flowchart illustrating an example of an operation for scrolling the list 73 in the image forming apparatus 2. In a manner similar to the above-described operation for counting history information, first, the authenticating means 201 performs authentication of a user (S10), and the display control means 206 performs control such that the list 73 is displayed in accordance with a function (S11).

Next, when the detecting means 204 detects a scroll operation for the list 73 (512: Yes), the determining means 205 determines whether or not the first content 74A is being displayed in the scroll region 71 (S13).

In the case where the first content 74A, that is, the content 74A that is extracted as a target for highlighting by the extracting means 203, is being displayed in the scroll region 71 (S13: Yes), the display control means 206 performs control such that the first content 74A is highlighted (S14).

In the case where the detecting means 204 detects that the scroll operation is stopped (S15: Yes), the determining means 205 determines whether or not highlighted content 74 is present in the scroll region 71 (S16).

In the case where highlighted content 74 is present in the scroll region 71 (S16: Yes), the display control means 206 performs control such that the content 74 is returned the original display state (S17).

### <First Modification>

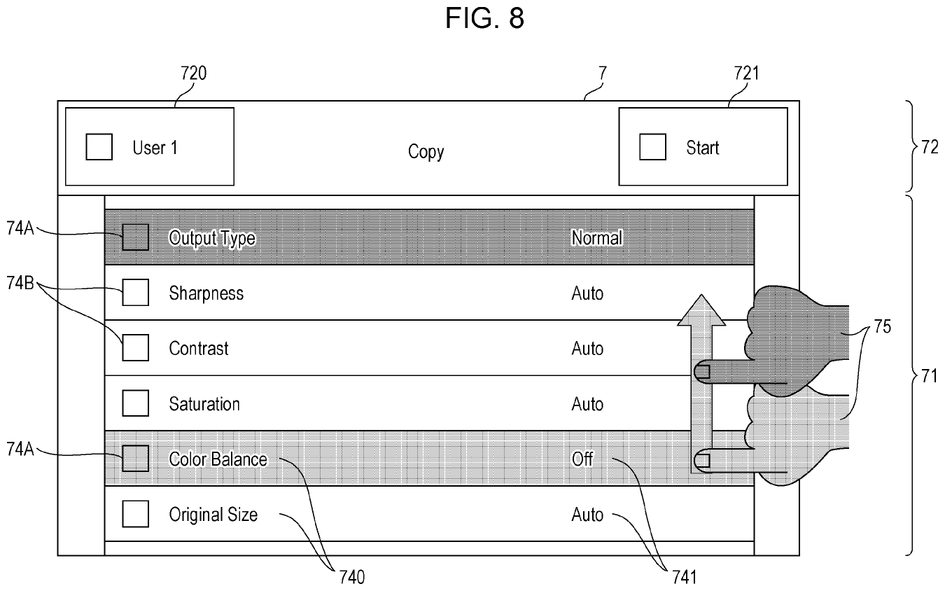

FIG. 8 is a diagram illustrating a modification of a display state of the setting display screen 7. The extracting means 203 may determine the number of setting times for each user to extract a first setting item for the user.

Specifically, as illustrated in FIG. 8, the display control means 206 may perform control such that third content 74C regarding an extracted setting item for which the number of times of setting by an operation by a user who is currently logging in (hereinafter, may be referred to as a “first user”) is equal to or more than a second reference number of times is displayed in a manner distinguished from fourth content 74D regarding an extracted setting item for which the number of times of setting by another user (hereinafter, may be referred to as a “second user”) is equal to or more than a third reference number of times.

The second reference number of times is an example of a predetermined second number. The third reference number of times is an example of a predetermined third number. The first reference number of times, the second reference number of times, and the third reference number of times may be different from one another, two of the reference numbers of times may be the same, or all the reference numbers of times may be the same. Furthermore, the third reference number of times may be larger than the second reference number of times.

Specifically, the display control means 206 may perform control such that the third content 74C and the fourth content 74D are displayed in different display states. More specifically, the display control means 206 may perform control such that the third content 74C and the fourth content 74D are displayed in different colors. The first user and the second user are examples of operators.

### <Second Modification>

Furthermore, the extracting means 203 may extract a plurality of first setting items. In this case, the number of first setting items to be extracted may be a predetermined number (for example, five or the like). Specifically, the extracting means 203 may extract a predetermined number of setting items in descending order of the number of setting times.

Furthermore, in the case where a plurality of first setting items are extracted, the display control means 206 may perform control such that a plurality of pieces of first content 74A corresponding to the first setting items are displayed in different colors. Furthermore, the display control means 206 may perform display with different densities (that is, gradation levels) according to the number of setting times.

### <Third Modification>

Furthermore, in the exemplary embodiments described above, the case where the counting means 208 counts the number of setting times for each user has been explained as an example. However, the counting means 208 may perform counting without distinguishing among users. That is, the counting means 208 may count the total number of times that setting has been performed without distinguishing among users who have performed setting, and counts the number of setting times as an attribute of a setting item.

### <Fourth Modification>

Furthermore, in the case where a plurality of first setting items are extracted, the display control means 206 may highlight a plurality of pieces of first content 74A one by one in order in accordance with a predetermined operation.

Specifically, first, the display control means 206 highlights the first first content 74A among a plurality of pieces of first content 74A. When a predetermined operation is performed, highlighting of the first first content 74A may be canceled and the second first content 74A may be highlighted. Furthermore, the above-mentioned operation may be repeated continuously the number of times corresponding to the number of extracted first setting items.

For example, highlighting may be performed in a descending order of the number of setting times or in the order of arrangement of the content 74 (for example, from the top to the bottom).

For example, the predetermined operation may include the following operations:

(A) a scroll operation is stopped when the first first content 74A is highlighted, and a scroll operation is then performed again; and

(B) a scroll operation is stopped when the first first content 74A is highlighted, and an operation for setting a setting value for a setting item corresponding to the first first content 74A is performed.

Furthermore, the display control means 206 may perform control such that when a target to be highlighted is changed from the first first content 74A to the second first content 74A, scroll is performed such that the second first content 74A is displayed in the scroll region 71 without any operation by an operation.

Exemplary embodiments of the present disclosure have been explained above. However, the exemplary embodiments of the present disclosure are not limited to the exemplary embodiments described above, and various modifications and implementations may be made without departing from the scope of the present disclosure. For example, a method for making the first content 74A more noticeable than the second content 74B only needs to be a method for making the first content 74A relatively noticeable compared to the second content 74B. For example, the first content 74A may be made to be relatively noticeable compared to the second content 74B by displaying the second content 74B to be less noticeable by graying out, reduction, or the like.

Furthermore, for example, the case where scroll is performed in the vertical direction has been explained in the foregoing exemplary embodiments. However, a scroll operation only needs to move in a direction from one end of the screen toward the other end opposing the one end. For example, the same applies to the case where scroll is performed in the horizontal direction from the left end to the right end of the screen.

Each of the plurality of pieces of means of the controller 20 may be partially or wholly configured as a hardware circuit such as a field programmable gate array (FPGA), an application specific integrated circuit (ASIC), or the like.

Furthermore, part of component elements in the foregoing exemplary embodiments may be omitted or changed without departing from the scope of the present disclosure. Furthermore, in flows in the foregoing exemplary embodiments, addition, deletion, change, replacement, and the like of steps may be performed without departing from the scope of the present disclosure. For example, the extracting means 203 may extract the first content 74A when the detecting means 204 detects a scroll operation or may extract the first content 74A in advance at a specific timing, regardless of whether or not the detecting means 204 detects a scroll operation.

Furthermore, a program used in the foregoing exemplary embodiments may be recorded in a computer-readable recording medium such as a compact disc-read only memory (CD-ROM) and provided. The program may be stored in an external server such as a cloud server and used via a network.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiment s were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
an extracting unit that extracts a specific item from among at least one or more items in accordance with history information indicating a history in which a setting value has been set; and
a display controller that performs control such that when a display target representing the extracted specific item is moved in a direction from one end of a screen toward the other end of the screen opposing the one end and displayed, the display target is displayed in a highlighted manner.

2. The information processing apparatus according to claim 1,
wherein the extracting unit extracts a plurality of specific items from among the at least one or more items, and
wherein the display controller performs control such that each of a plurality of display targets representing a corresponding one of the plurality of specific items is displayed in the highlighted manner.

3. The information processing apparatus according to claim 2,
wherein the display controller performs control such that the plurality of display targets are displayed in the highlighted manner in different states.

4. The information processing apparatus according to claim 1,
wherein the history information includes information indicating the number of times that the setting value has been set, the information being recorded in association with the at least one or more items, and
wherein the extracting unit extracts the specific item in a case where the number of times recorded in the history information is equal to or more than a predetermined first number.

5. The information processing apparatus according to claim 4,
wherein the history information further includes identification information for identifying an operator who has set the setting value, the identification information being recorded in association with the at least one or more items, and
wherein the extracting unit extracts the specific item in a case where the number of times that an operator who has issued an instruction to move the display target on the screen has set the setting value is equal to or more than a predetermined second number.

6. The information processing apparatus according to claim 5,
wherein the extracting unit extracts the specific item in a case where a total sum of the numbers of times that a plurality of operators have set the setting values is equal to or more than a predetermined third number.

7. The information processing apparatus according to claim 6,
wherein the extracting unit extracts a plurality of specific items in accordance with the total sum of the numbers of times that the plurality of operators have set the setting values, and
wherein the display controller performs control such that a plurality of display targets representing a plurality of items are displayed in the highlighted manner in different states in accordance with the plurality of operators.

8. The information processing apparatus according to claim 1,
wherein the display controller performs control such that when an operation for moving a list of the items from the one end of the screen toward the other end of the screen is stopped, displaying the specific item in the highlighted manner is stopped.

9. A non-transitory computer readable medium storing a program causing a computer to execute a process for information processing, the process comprising:
extracting a specific item from among at least one or more items in accordance with history information indicating a history in which a setting value has been set; and
performing control such that when a display target representing the extracted specific item is moved in a direction from one end of a screen toward the other end of the screen opposing the one end and displayed, the display target is displayed in a highlighted manner.

10. An information processing apparatus comprising:
extracting means for extracting a specific item from among at least one or more items in accordance with history information indicating a history in which a setting value has been set; and
display control means for performing control such that when a display target representing the extracted specific item is moved in a direction from one end of a screen toward the other end of the screen opposing the one end and displayed, the display target is displayed in a highlighted manner.
